(19) United States
(12) Patent Application Publication
(10) Pub. No.: US 2022/0410461 A1
(43) Pub. Date: Dec. 29, 2022

(54) METHOD OF MANUFACTURING A CONTAINER

(71) Applicant: Gaplast GmbH, Altenau (DE)

(72) Inventors: Roland Kneer, Farchant (DE); Stephan Kneer, Farchant (DE); Kasim Yilginc, Oberammergau (DE)

(21) Appl. No.: 17/844,999

(22) Filed: Jun. 21, 2022

(30) Foreign Application Priority Data
Jun. 23, 2021 (DE) 10 2021 116 278.5

(51) Int. Cl. B29C 49/04

(52) U.S. Cl. CPC B29C 49/04116; B29C 49/0412; B29L 2009/001

(57) ABSTRACT

A method of manufacturing a container includes removing a section of the base web of the outer container so that a section of the base seam of the inner container is exposed to the exterior; raising the exposed section of the base seam into the outer container so that an opening is produced between the base seam of the inner bag and the outer container, introducing a pressure medium into the opening, whereby the inner bag detaches from the outer container on both sides, and supplying a pressure medium into the container opening so that the inner bag again engages the outer container.

### PRIORITY CLAIM

The subject application claims convention priority to German patent application No. DE 10 2021 116 278.5, filed Jun. 23, 2021.

### FIELD OF THE INVENTION

The invention relates to a method of manufacturing a container which includes a substantially stiff outer container and a readily deformable inner bag, which are made of thermoplastic plastic materials, which do not form a weld connection with one another.

### BACKGROUND

A method of manufacturing a container which includes a substantially stiff outer container and a readily deformable inner bag, which are made of thermoplastic plastic materials, which do not form a weld connection with one another, wherein the container has a container opening and the outer container has at least one wall opening, through which a pressure balance occurs in the gap between the inner bag and the outer container when the inner bag contracts as a result of discharging its contents, is known. In the method, a preform, which has at least two layers, is coextruded and arranged between the open halves of a blow mould, wherein the blow mould is closed when the preform has the length necessary for the manufacture of the container. Excess material in the base region of the container to be manufactured is squeezed out and an outwardly projecting web of welded material of the outer container is formed, in which the welded base seam of the inner bag is clamped and held in the axial direction. Thereafter, the preform is inflated by a pressure medium, generally compressed air, into engagement with the wall of the blow mould and removed from the blow mould.

In containers with substantially stiff outer containers and readily deformable inner bags, different types of thermoplastic plastic materials are used for the outer container and the inner bag and they do not form a weld connection with one another but they adhere to one another with considerable adhesive forces when the container is manufactured in a coextrusion process. Before such a container is capable of being used, i.e. is filled with a liquid or, for instance, also gel-like container contents, which is then gradually discharged, for instance by means of an airless pump or, in the case of a squeeze container, by compressing it, the inner bag must be detached from the wall of the outer container and then applied to it again.

This can occur in the manner that a reduced pressure is applied to the inner bag through the container opening, which then contracts abruptly. The inner bag, the base seam of which is clamped in the base web of the outer container, thus becomes detached in a more or less uncontrolled manner from the outer container, whereby it can also occur that the inner bag becomes detached only on one side. A pressure medium, generally compressed air, is then introduced into the inner bag through the container opening in order to apply it again to the outer container so that the inner bag can reach the intended filling volume.

A method of releasing the inner bag from the outer container is disclosed in DE102006012487 B4, in which at least one wall opening is formed by the wall of the outer container being drilled through or pierced by a drill or puncture needle, wherein after completely penetrating the wall of the outer container compressed air is introduced into the gap between the container and the inner bag. As a result, the inner bag becomes detached from the wall of the outer container, whereby compressed air is supplied into the gap between the inner bag and the outer container until a predetermined pressure value is measured in the inner bag with the container opening having been previously sealed. It is not ensured with this procedure that the inner bag becomes uniformly detached from the outer container on both sides.

When the inner bag is not detached substantially uniformly from the wall of the outer container, a relatively large sub-atmospheric pressure occurs in the inner bag as a consequence of the discharge of filling material despite pressure balance openings in the wall of the outer container. The larger this sub-atmospheric pressure, the greater is the permeation through the very thin wall of the inner bag and the risk that this becomes leaky. If the sub-atmospheric pressure in the inner bag becomes too large, this can also involve the functionality of the pump which is generally provided so that not all the contents of the container can be discharged.

It is the object of the present invention to provide a method in which the inner bag can be uniformly detached from the outer container and applied again to the outer container.

An apparatus is also to be specified with which this method may be performed.

These objects are solved in accordance with the invention by the features of the claims.

Advantageous embodiments of the invention are characterised in the dependent claims.

### SUMMARY OF THE INVENTION

The invention relates to a method of manufacturing a container which includes a substantially stiff outer container and a readily deformable inner bag, which are made of thermoplastic plastic materials, which do not form a weld connection with one another, wherein the container has a container opening and the outer container has at least one wall opening, through which a pressure balance occurs in the gap between the inner bag and the outer container when the inner bag contracts as a result of discharging its contents. In the method, a preform, which has at least two layers, is coextruded and arranged between the open halves of a blow mould, wherein the blow mould is closed when the preform has the length necessary for the manufacture of the container. Excess material in the base region of the container to be manufactured is squeezed out and an outwardly projecting web of welded material of the outer container is formed, in which the welded base seam of the inner bag is clamped and held in the axial direction. Thereafter, the preform is inflated by a pressure medium, generally compressed air, into engagement with the wall of the blow mould and removed from the blow mould.

The method of the invention provides, as the first step, that a small section of the base web of the outer container is removed so that a section of the base seam of the inner bag clamped in the base web is exposed to the exterior.

It is preferred that the section of the base web is cut away, for which purpose a circular cutter is used with particular advantage. This cut away section should be located in the central region of the weld seam, seen in its longitudinal direction. The cut is performed transversely through the weld seam and only so deep that the inner bag cannot become leaky.

The next step of the method includes the step of the exposed section of the base seam being lifted or pressed into the outer container, whereby an opening is produced between the base seam of the inner bag and the outer container. An opening is thus formed on both sides of the base seam of the inner bag, into which, during the raising of the base seam or subsequent thereto, a pressure medium is introduced, which flows on both sides of the inner bag up to the neck region of the container and thereby detaches the inner bag from the outer container on both sides.

Compressed air is preferably used as the pressure medium.

The exposed section of the base seam can be raised by any suitably shaped tool, whereby a pin-shaped blow mandrel is used with particular advantage as the tool, through which the pressure medium can be blown into the opening simultaneously.

In the method in accordance with the invention, the inner bag is completely detached on both sides with a minimal cycle duration, without damage occurring to the inner bag, such as white fracture or the disadvantageous forming of folds.

The concluding step of the method in accordance with the invention includes the step of the supply of a pressure medium into the container opening, which is known per se, so that the inner bag again engages the outer container, specifically without lasting deformation of the inner bag during the detaching process, i.e. without the formation of folds and without trapping air between the inner bag and outer container.

The outer container and the inner bag can each have one or more layers, which do not form a weld connection with one another during coextrusion. The outer container frequently includes an oxygen diffusion barrier layer. This oxygen diffusion barrier is cut away in the method in accordance with the invention only at a single small portion of the weld seam, where the container has its highest material thickness. This has the result that only an extremely low oxygen diffusion occurs into the inner bag.

Since only a small, central section of the weld seam of the container is cut away and this region is exactly limited, above all when using a circular cutter, the inner bag remains reliably anchored with its welded base seam in the undamaged region of the base web of the outer container on both sides so that the inner bag is fixed in the outer container in the axial direction and can contract only in the radial direction when dispensing the contents of the container.

The method in accordance with the invention was performed on a bottle-shaped container with a capacity of 12.5 cm³ with the following preferred details: the weld seam was cut away over a length of approximately 4 mm with a cut depth of approximately 3 mm in the middle of the ca. 27 mm long weld seam with a circular cutter in a single cut, which was performed perpendicular to the weld seam. The detaching tool had a pin-like blow mandrel with a length of about 7 mm, whereby the mandrel was introduced approximately 2.5 mm. The air pressure nozzles on the mandrel had a diameter between 0.5 mm and 1.5 mm, depending on the adhesion of the inner bag.

As a result, the complete, uniform detachment of the inner bag from the outer container and the smooth engagement once again of the inner bag was achieved in significantly shortened working steps.

The cut away length of the weld seam and the cut depth should be varied appropriately with other types of bottle.

### BRIEF DESCRIPTION OF THE DRAWINGS

FIG. 1 is a vertical sectional view through the center of a container;

FIG. 2 is a sectional view of the container with a base web cut away; and

FIG. 3 is a vertical sectional view of an exposed section of a base seam that is raised by a mandrel.

### DETAILED DESCRIPTION OF THE INVENTION

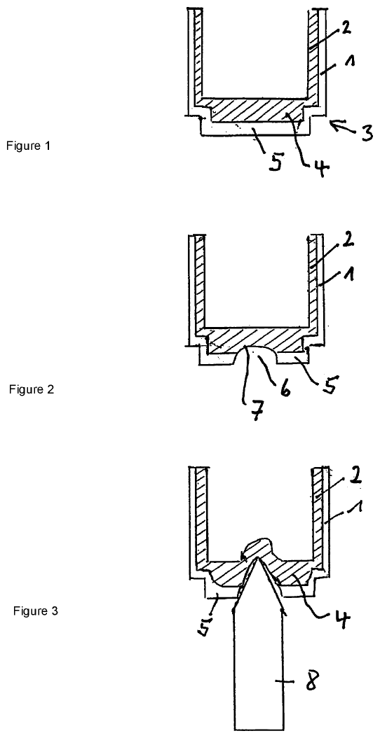

FIG. 1 is a central, vertical sectional view through a container, which includes a stiff outer container 1 and an engaging inner bag 2. The vertical section extends in the longitudinal direction centrally through the base weld seam 3, in which the welded base seam 4 of the inner container 2 is clamped in the base web 5 of welded material of the outer container 1.

In FIG. 2, a section 6 of the base web 5 is cut away with a circular cutter, which is not shown, so that a section 7 of the base seam 4 of the inner bag 2 is exposed to the exterior.

FIG. 3 shows that the exposed section 7 of the base seam 4 is raised into the container by a mandrel 8, whereby an opening is produced between the base seam 4 of the inner bag 2 and the outer container 1, into which compressed air is introduced, whereby the inner bag 2 detaches from the inner wall of the outer container 1 on both sides of the weld seam 3.

An apparatus in accordance with the invention for performing the method includes a mounting device for the container to be processed, a cutting device with a circular cutter, which removes a section of the weld seam of the container fixed in position in the mounting device in a single cut and a detaching device, which includes a detaching pin, which is connected to a source of compressed air and is advanced and thereby forces the weld seam into the container.

1. A method of manufacturing a container having of a substantially stiff outer container and a readily deformable inner bag of thermoplastic plastic materials which do not form a weld connection with one another, with a container opening and at least one wall opening in the outer container, through which a pressure balance occurs in the gap between the inner bag and the outer container, wherein a preform having at least two tubes is coextruded and is arranged between the open halves of a blow mould and the blow mould is closed, when the preform has the length necessary for the manufacture of the container, wherein excess material is squeezed out in the base region of the container to be manufactured and a weld seam is formed, which has a base web of welded material of the outer container, in which the welded base seam of the inner bag is clamped and is held in the axial direction and the preform is inflated by a pressure medium into engagement with the wall of the blow mould and is removed from the blow mould, the method comprising the following steps:
a) removing a section of the base web of the outer container so that a section of the base seam of the inner container is exposed to the exterior;
b) raising the exposed section of the base seam into the outer container so that an opening is produced between the base seam of the inner bag and the outer container,
c) introducing a pressure medium into the opening, whereby the inner bag detaches from the outer container on both sides,
d) supplying a pressure medium into the container opening so that the inner bag again engages the outer container.

2. A method as claimed in claim 1, wherein the section of the base web is cut away.

3. A method as claimed in claim 2, wherein a circular cutter is used for the cutting away of the section of the base web.

4. A method as claimed in claim 1, wherein a central section of the base web is removed or cut away.

5. A method as claimed in claim 1, wherein compressed air is used as the pressure medium.

6. A method as claimed in claim 1, wherein the exposed section of the base seam is raised by a tool.

7. A method as claimed in claim 6, wherein a blow mandrel is used as the tool, through which the pressure medium is blown into the opening.

8. An apparatus for manufacturing a container having of a substantially stiff outer container and a readily deformable inner bag of thermoplastic plastic materials which do not form a weld connection with one another, with a container opening and at least one wall opening in the outer container, through which a pressure balance occurs in the gap between the inner bag and the outer container, wherein a preform having at least two tubes is coextruded and is arranged between the open halves of a blow mould and the blow mould is closed, when the preform has the length necessary for the manufacture of the container, wherein excess material is squeezed out in the base region of the container to be manufactured and a weld seam is formed, which has a base web of welded material of the outer container, in which the welded base seam of the inner bag is clamped and is held in the axial direction and the preform is inflated by a pressure medium into engagement with the wall of the blow mould and is removed from the blow mould, the apparatus for manufacturing comprising:
a) a mounting device, in which a container to be processed may be fixed,
b) a cutting device with a circular cutter, which is arranged to be advanceable, and
c) a detaching device, with a blow mandrel, which is mounted to be advanceable and which is connected to a source of compressed air.
